(19) United States
(12) Patent Application Publication
(10) Pub. No.: US 2024/0292975 A1
(43) Pub. Date: Sep. 5, 2024

(54) BEVERAGE PREPARATION MACHINE AND METHOD FOR DISPENSING A LIQUID

(71) Applicant: SOCIETE DES PRODUITS NESTLE S.A., Vevey (CH)

(72) Inventors: ALEXANDRE PUGLIESE, Paudex (CH); ALEXANDRE PERENTES, Sullens (CH); ANTONIN BENOIT-LIZON, Morges (CH); NICOLAS GANSHOF VAN DER MEERSCH, Vufflens-le-Chateau (CH)

(21) Appl. No.: 18/572,534

(22) PCT Filed: Jun. 15, 2022
(86) PCT No.: PCT/EP2022/066304

§ 371 Date: Dec. 20, 2023

(30) Foreign Application Priority Data
Jun. 23, 2021 (EP) 21181236.7

(51) Int. Cl. A47J 31/60; A47J 31/44; A47J 31/46; B67D 1/00

(52) U.S. Cl. CPC A47J 31/60; A47J 31/4428; A47J 31/461; A47J 31/469; B67D 1/0021

(57) ABSTRACT

The invention relates to a beverage preparation machine (1), comprising a delivery unit (2) for delivering a liquid through the beverage preparation machine (1), a dispensing unit (3) for dispensing the liquid delivered by the delivery unit (2), and a collection unit (8) being fluidly connectable to the dispensing unit (3) to selectively form a liquid path (P) to collect the liquid dispensed by the dispensing unit (3). The invention further relates to a method for dispensing a liquid, comprising (a) delivering a liquid through a delivery unit (2) of a beverage preparation machine (1), preferably the beverage preparation machine (1) of any one of the preceding claims, (b) dispensing the liquid delivered by the delivery unit (2) via a dispensing unit (3) of the beverage preparation machine (1), and (c) selectively fluidly connecting a collection unit (8) of the beverage preparation machine (1) with the dispensing unit (3) to form a liquid path (P) for collecting at least part of the liquid dispensed by the dispensing unit (3).

### 1. FIELD OF THE INVENTION

The present invention is directed to a beverage preparation machine for dispensing a (comestible) liquid or beverage, like water, flavored water, enriched water, coffee, tea, soup, and the like, e.g. by interaction of the liquid (e.g. water) with a comestible product (e.g., in a pourable, powdery, gel, pasty, or liquid form) preferably carried in a capsule, pad, pod, sachet, container, and the like. The invention is further directed to a method for dispensing a liquid, like the mentioned comestible liquid or beverage (product).

### 2. TECHNICAL BACKGROUND

Beverage preparation machines are generally known in the prior. With these machines, a liquid is delivered through the machine to be dispensed at a dispensing outlet. The liquid may be tempered (e.g. chilled or heated) before being dispensed. The liquid may interact with a comestible product to prepare a particular beverage product or other liquid comestible, like coffee, tea or soup. The liquid may also interact with the comestible product to be enriched or flavored before being dispensed. The liquid may be delivered through a preparation unit for interacting with the comestible product. Therefore, the comestible product can be carried in a capsule or other type of recipient, which can be selectively placed in the preparation unit so as to allow the liquid enter the capsule for interacting with the comestible product.

The liquid or beverage is usually dispensed into a drinking vessel placed below the dispensing outlet. The drinking vessel is therefore usually placed onto a receiving base which is positioned below the dispensing outlet. The receiving base can be designed as a drip tray for receiving any liquid exiting the dispensing outlet if no drinking vessel is placed on the base. This exiting liquid can be dispensed liquid upon a beverage preparation process, residues after beverage preparation, cleaning liquids during a cleaning cycle, and the like.

### 3. SUMMARY OF THE INVENTION

It is thus an object of the present invention to provide a beverage preparation machine and a method for dispensing a liquid, which allow for a clean and safe use.

According to an aspect, the present invention is directed to a beverage preparation machine, comprising a delivery unit for delivering a liquid through the beverage preparation machine, a dispensing unit for dispensing the liquid delivered by the delivery unit—e.g. from the beverage preparation machine—, and a collection unit being fluidly connectable to the dispensing unit to selectively form a (e.g. closed or bypass) liquid path to collect (e.g. at least part of) the liquid dispensed by the dispensing unit

Thus, as the beverage preparation machine comprises a collection unit which can be fluidly connected to the dispensing unit, a liquid path can selectively be formed by means of which any liquid dispensed or discharged by the dispensing unit can be collected. Hence, any external dripping after Liquid or beverage dispensing can be avoided, so that a user or a drinking vessel of a subsequent user will not be contaminated, e.g. with residues of the previously dispensed liquid. In case of heated liquids be dispensed, scalding can be avoided if residues are collected by the collection unit. Also, steam created due to heating liquid inside the machine for dispensing heated liquid and which may exit the dispensing unit can be collected via the liquid path as well, thus further reducing a risk for the user, e.g. due to scalding. Also, in case of a cleaning step, the liquid path can be formed to thus avoid the cleaning liquid getting into contact with a user or even be dispensed into a drinking vessel placed, e.g. on a base, below the dispensing unit. In the context of the present invention, the term “cleaning” may preferably encompass rinsing, purging, cleaning, descaling, sanitizing, and every other type of cleaning. Hence, a “cleaning liquid” can be any type of liquid for improving the machine's cleanliness, like heated/hot liquid, water, descaling agent, sanitizer, disinfectant, etc. In sum, the use of the beverage preparation machine is thus made clean(er) and safe(r), preferably compared to the machines as previously described. Also, the risk of cross-contamination can be minimized.

The dispensing unit may preferably comprise an outlet port for dispensing the liquid; e.g. from the beverage preparation machine preferably in a drinking vessel. Hence, a defined, e.g. specifically directed and/or controlled, and thus clean dispensing can be obtained.

The collection unit may preferably comprise an inlet port for being fluidly connectable to the dispensing unit, preferably the outlet port, to form the liquid path. Hence, a well defined part for receiving and collecting liquid dispensed by the dispensing unit at any desired time can be provided. Thus, the liquid path can be optimized for a very clean and safe collection of liquid and thus corresponding use of the machine.

The collection unit, preferably at the inlet port, may preferably comprise a cup-shaped receiving section for receiving at least part of the dispensing unit, preferably at least the outlet port, when being fluidly connected to the dispensing unit to form the liquid path. Hence, clean and safe collection of any liquid dispensed by the dispensing unit can be obtained, as the cup-shaped receiving section allows for a secure enclosure of the dispensing unit or outlet port, and thus a preferably safely closed liquid path when being fluidly connected.

The collection unit, preferably at least the inlet port, may preferably be relatively moveable with respect to the dispensing unit, preferably at least the outlet port, between a connected position to fluidly connect the collection unit with the dispensing unit to form the liquid path, and a retracted position to allow the dispensing unit for dispensing the liquid out of the beverage preparation machine. These defined positions allow for a dedicated positioning of the collection unit relative to the dispensing unit to allow for a desired liquid dispensing in the retracted position, and a clean and safe as well as reproducible liquid collection in the connected position. Forming the liquid path and clearing the dispensing unit can thus be intuitively obtained so that handling errors can be minimized.

The collection unit, preferably at least the inlet port, and/or the dispensing unit, preferably at least the outlet port, can be preferably moveable by a rotational and/or linear movement, and more preferred along a defined trajectory. The defined movability allows for a defined movement and thus a repeatedly accurate and safe creation of the liquid path on the one hand, and clearing of the dispensing unit for free dispensing on the other hand. The movement is preferably obtained by a parallelogram guide mechanism, which allows for a simple but reliable arrangement.

The beverage preparation machine may preferably further comprise a biasing means, e.g. a biasing element, for allowing the dispensing unit, preferably the outlet port, and the collection unit, preferably the inlet port, be biased relative to each other towards or away from forming the fluid connection, preferably towards the connected position or the retracted position. Hence, reaching a defined relative position between these units can be supported. If the biasing means biases towards the fluid connection or connected position, the flow path can easily be obtained and safely maintained. If the biasing means biases away from the fluid connection or towards the retracted position, minimal or no energy is required to maintain these units in the general operational condition.

The biasing means may preferably comprise a spring, and/or a material and/or a design of at least part of the collection unit and/or the dispensing unit; this preferably for preloading at least one of the collection unit and the dispensing unit relatively to each other. A spring is a standardized and thus easily obtainable element. If the biasing means is integrated in the material or design of the at least part of the respective unit, the overall layout of the machine can be facilitated and the number of pieces be reduced. As a material, the biasing means may be an integral part made of rubber, like a rim of the inlet and/or outlet port. As a design feature, a supporting arm of the collection unit may have a defined length to allow for a defined flexibility. Also, the rim of the inlet and/or outlet port may be structured or segmented to have a defined flexibility to allow for a required biasing function.

A sealing element may preferably be provided between the dispensing unit, preferably the outlet port, and the collection unit, preferably the inlet port, for sealingly closing the liquid path when being fluidly connected. Hence, the liquid path can be provided in a secure, leak-proof and thus safe manner. Preferably, the sealing element may be integrally provided with the biasing means, e.g. in the form of a circumferential rubber rim section of the inlet and/or outlet port.

The collection unit, preferably at a portion downstream from the inlet port, can preferably be fluidly connected to a receptacle for collecting the liquid. Hence, the practicability of the machine can be enhanced, as the liquid can be stored and removal or disposal of the collected liquid can be deferred to desired point in time. Also, any residues or other liquids can be safely stored. This is particularly advantageous if the collected liquid is a cleaning liquid. A feedback means (e.g. lamp, display, loudspeaker, etc.) may be provided to indicate the need for emptying the receptacle when being full; e.g. by a visual feedback (e.g. indicator lamp, display, etc.) or acoustic feedback (e.g. by a beep, voice instruction, etc.).

The receptacle can preferably be a drip tray being even more preferred positioned below the dispensing unit. Hence, the receptacle can be integrated in an often present feature of such a machine, thus facilitating the overall layout without affecting the dimensions and design of the machine.

The collection unit and/or, if present, the receptacle can preferably be fluidly connected or connectable to the delivery unit to form a closed circulation loop. Hence, the collected liquid can be reused, if desired. This can, for instance, be useful for a cleaning cycle, which allows for an economic use of the required cleaning liquids.

The beverage preparation machine may preferably further comprise a flow restriction element, such as a pinch valve, for selectively restricting or stopping the dispensing of liquid through the dispensing unit. This feature may allow for a defined interaction of the liquid, e.g., with a comestible product carried in the dispensing unit. Also, a cleaning liquid may be held within the machine for a defined cleaning period to allow for a sufficient purgation of the machine.

The flow restriction element can preferably be moveable between a flow restriction position to restrict or stop the liquid flowing through the dispensing unit, and a flow position to allow free flow of the liquid through the dispensing unit. Hence, the flow of liquid through the dispensing unit can be easily and accurately controlled.

The flow restriction element may preferably comprise a restriction head being moveable relative to a flexible delivery line section (e.g. of the delivery unit and/or the dispensing unit) so that a cross-section of a liquid flow path through the delivery line section is selectively reduced or eliminated, preferably in the flow restriction position. Hence, the restriction function can be easily provided. This layout is also low-maintenance.

A movement of the flow restriction element can preferably be at least partially linked to a relative movement of the collection unit with respect to the dispensing unit, preferably such that, preferably along an at least partially continuous combined movement, the flow restriction element is in the restriction position while the collection unit is in the retracted position, then the flow restriction element is in the flow position while the collection unit is in the retracted position, and then the flow restriction element is in the flow position while the collection unit is in the connected position, and backwards. This combined movement simplifies the overall layout of the machine and facilitates reaching the respective positions. Also, misuse can thus be avoided.

The beverage preparation machine may preferably further comprise an actuator for moving the collection unit and/or the dispensing unit and, if present, preferably also the flow restriction element. The actuator can move the respective part directly. This can be done, for instance, through a gear train, which can be provided between the respective parts. The actuator may also move at least some of the respective parts indirectly, e.g. through one of the other moveable parts being directly moved. The directly and indirectly moved parts can therefore be in contact (e.g. moveably linked) or come into contact to at least partially move together in a linked movement.

The beverage preparation machine may preferably further comprise a UV lamp for irradiating the dispensing unit, preferably the outlet port, and/or the collection unit, preferably the inlet port; i.e. exposing these parts with UV light. Hence, a desired sanitization of the so exposed parts for dispensing and/or forming the liquid path can be obtained. This also results in a reduced cross-contamination.

The UV lamp may be preferably provided at the collection unit so that it is directed towards the dispensing unit, preferably the outlet port, when being fluidly connected to the dispensing unit. This may allow for sanitizing the inlet port upon or before creating the liquid path. Alternatively or additionally, the UV lamp may be preferably provided at the dispensing unit so that it is directed towards the collection unit, preferably the inlet port, when being fluidly connected to the collection unit. This may allow for sanitizing the outlet port upon or before creating the liquid path. The UV lamp(s) may also be provided at other locations as long as allowing UV irradiation of the respective parts for sanitizing purposes.

The beverage preparation machine, preferably the delivery unit, may preferably comprise a heater for heating the liquid, preferably in the delivery unit. Hence, liquid can be heated for preparing and/or dispensing a heated liquid or beverage. Also, liquid, like water, may be heated to be used for cleaning (e.g. rinsing) purposes. The so heated water may then be delivery through the machine and the liquid path and preferably also be re-circulated.

The beverage preparation machine, preferably the delivery unit, may preferably comprise a pump for delivering the liquid through the beverage preparation machine (i.e. including the liquid path, if present). Hence, the liquid can be easily delivered and (re-)circulated.

The beverage preparation machine may preferably further comprise a control unit configured for delivering the liquid, preferably by controlling the pump, and/or for selectively fluidly connecting the collection unit to the dispensing unit, preferably by controlling the actuator to move the collection unit relatively to the dispensing unit, and/or for restricting or stopping the liquid flow, preferably by moving the flow restriction element. Of course, the control unit may also be configured for heating and/or chilling the liquid, preferably by controlling the heater (i.e. for heating) and/or a cooling unit (i.e. for cooling).

According to another aspect, the present invention is directed to a method for dispensing a liquid, comprising:
delivering a liquid through a delivery unit of a beverage preparation machine, preferably the beverage preparation machine as defined herein above,
dispensing the liquid delivered by the delivery unit via a dispensing unit of the beverage preparation machine, and
selectively fluidly connecting a collection unit of the beverage preparation machine with the dispensing unit to form a liquid path for collecting (e.g. at least part of) the liquid dispensed by the dispensing unit.

Hence, for the reasons already presented herein above for the beverage preparation machine, a method for dispensing a liquid is provided which allows for a clean and safe use of a beverage preparation machine. To avoid repetitions, it is referred to the remarks and advantageous as presented herein above.

The step of delivering a liquid may preferably comprise preparing a beverage based on the liquid, preferably in a beverage preparation chamber upstream from or inside the dispensing unit. The beverage preparation chamber can, for instance, be a mixing chamber or a brewing chamber. For instance, a beverage additive section may be provided (e.g. as part of the delivery unit) to deliver an additive for mixing with the liquid. Also, a comestible product may be carried in a capsule being inserted in the beverage preparation chamber for being injected with the liquid for brewing and/or infusion and/or dissolution of the comestible product. Hence, the liquid can be further enhanced and/or enriched, e.g. by interaction with a comestible product, to produce a corresponding beverage to be dispensed. The step of dispensing the liquid may then further comprise dispensing the prepared beverage via the dispensing unit.

Preferably, at the start of preparing the beverage, the dispensing of beverage can be restricted or stopped, and after a defined duration after the start of the beverage preparation, the dispensing of the prepared beverage can be started. This step allows for withholding liquid inside the machine, e.g. for sufficiently interacting with a comestible product to prepare a beverage, or for sufficiently cleaning the machine, or simply to avoid any dripping or dispensing out of operation or between two consecutive dispensing commands, e.g. from users.

The liquid path may preferably be formed before the step of dispensing the liquid or prepared beverage is started, then the dispensing of liquid or prepared beverage is started, and after a defined duration, the dispensing unit is cleared from the collection unit to freely dispense the liquid or prepared beverage. Hence, an unwanted initial liquid amount can be collected. A reason can be that the initial amount of liquid may not yet comprise a sufficiently prepared beverage or comprise some stale residues from inside the machine. Also, in case of heated liquid, some steam may be created inside the machine which can thus be collected to avoid any risks for the user, e.g. due to scalding.

The liquid path may preferably be formed after the dispensing of liquid or prepared beverage is terminated. Hence, dispensing or dripping of any residues can be avoided. Also, the dispensing unit (e.g. outlet port) can be securely stored out of operation to avoid any cross-contamination. Moreover, if UV lamp is present, a sanitization of the inlet port and outlet port can be easily obtained.

The step of fluidly connecting may preferably comprise relative movement between the dispensing unit and the collection unit, preferably to fluidly connect an outlet port of the dispensing unit and an inlet port of the collection unit. Preferably, these units can be relatively moved between the mentioned retracted position and connected position. Hence, the fluid path can be easily formed and the dispensing unit be cleared, if desired.

The step of collecting (at least part of) the liquid may preferably comprise collection of the respective liquid or prepared beverage in a receptacle and/or recirculating the liquid to the delivery unit. Hence, the collected liquid can be easily stored. For instance for cleaning purposes, the liquid may be a cleaning liquid which can be recirculated for an economic purgation of the machine.

The liquid can preferably be heated or cooled before or during delivery of the liquid. Hence, a hot or cold beverage may be provided. Also, the heated liquid may be used for cleaning (e.g. rinsing) purposes and preferably be re-circulated as described herein above for economic cleaning of the machine.

The dispensing unit, preferably the outlet port, and/or the collection unit, preferably the inlet port, can preferably be cleaned or sanitized, preferably before, during and/or after the dispensing and/or collection of liquid or prepared beverage. Hence, the lifetime of the machine can be prolonged and dispensed product, particularly if intended for consumption, can be increased in safety. The cleaning or sanitization can be done by delivering or circulation a corresponding (cleaning) liquid through the machine and preferably also—i.e. including—the liquid path. At the end of this step, the corresponding liquid may be collected via the collection unit, e.g. in the receptacle. The step of sanitization may preferably also comprise irradiating UV light to the dispensing unit and/or the collection unit, e.g. by the UV lamps as described herein above; this preferably in a state of the fluid connection be formed and thus when the flow path is created.

### 4. BRIEF DESCRIPTION OF DRAWINGS

Further features, details and advantages of the present invention will now be described in relation to the embodiments of the enclosed figures.

FIG. 1 shows a perspective cross-sectional view of parts of a beverage preparation machine according to a first embodiment of the present invention.

FIG. 2 shows a perspective view of parts of a beverage preparation machine according to a second embodiment of the present invention.

FIG. 3 shows a perspective cross-sectional view of the parts of the beverage preparation machine of FIG. 2.

FIG. 4 shows a cross-sectional side view of parts of the beverage preparation machine according to FIG. 2 with the collection unit in the retracted position and the flow restriction element in the restriction position.

FIG. 5 shows a cross-sectional side view of the parts of the beverage preparation machine according to FIG. 4 with the collection unit in the retracted position and the flow restriction element in the flow position.

FIG. 6 shows a cross-sectional side view of the parts of the beverage preparation machine according to FIG. 4 with the collection unit in the connected position and the flow restriction element in the flow position.

FIG. 7 shows a schematic view of a beverage preparation machine according to a third embodiment of the present invention.

### 5. DETAILED DESCRIPTION

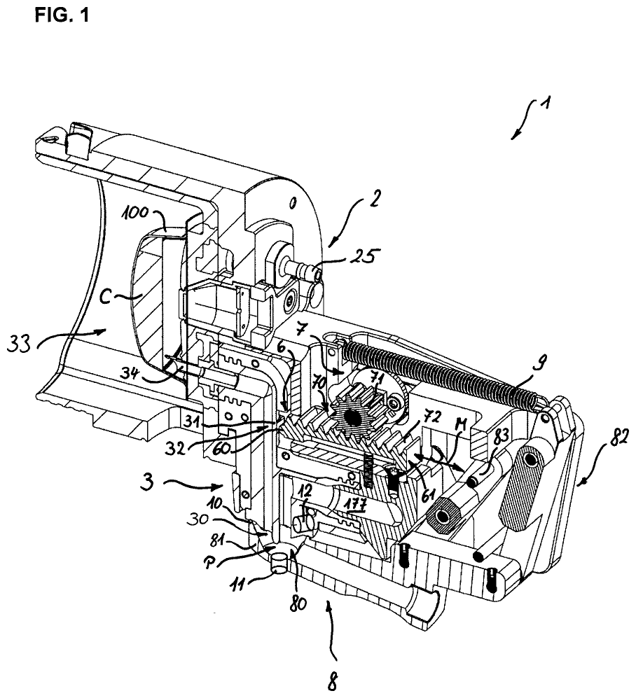

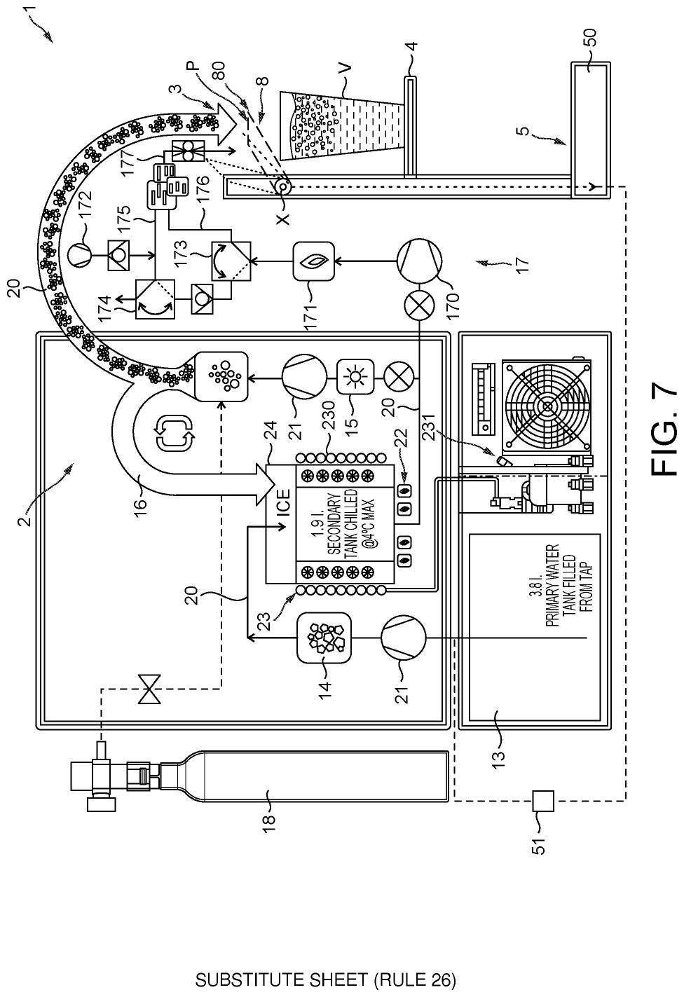

The Figures show different embodiments of a beverage preparation machine 1 as well as particular details and parts thereof. The embodiments of FIGS. 1 to 6 exemplarily show brewing- or infusion-type beverage preparation machines 1. The embodiment of FIG. 7 shows a dispenser-type beverage preparation machine 1. The beverage preparation machine 1 may be adapted for being used by a consumer, who requests (on demand) a beverage from the beverage preparation machine 1. That is, the beverage preparation machine 1 may be adapted to discharge or dispense a beverage that is ready for drinking by the consumer, i.e. a ready-to-drink beverage. The beverage preparation machine 1 is not limited to a specific design. Preferably, the beverage preparation machine 1 is designed to be used on the side of a business (B2B) and/or on the side of a customer (B2C). For example, the beverage preparation machine 1 may be designed as a vending machine (airport, mall, public area, etc.), in B2B (hotel, restaurant, café, i.e. “HoReCa”, fitness center, office, etc.) and/or B2C (e.g., at home). The beverage preparation machine 1 may be designed as a vending machine, a water dispenser, and/or a home appliance device. The beverage preparation machine 1 may be designed for being mounted or positioned to a wall (wall-mounted), a bottom, and/or a tabletop, and/or the beverage preparation machine 1 may have a freestanding design. The beverage preparation machine 1 may comprise a connection for a power supply in order to supply the respective components of the beverage preparation machine 1 with electrical energy.

The beverage preparation machine 1 comprises a delivery unit 2 for delivering liquid through the beverage preparation machine 1. The delivery unit 2 is exemplarily shown for a dispenser-type beverage preparation machine 1 in FIG. 7. The delivery unit 2 may comprise at least one or a plurality of delivery lines 20 to form a passage for delivering the liquid through the delivery unit 2 and thus the beverage preparation machine 1. The delivery unit 2 may also comprise one or a plurality of pumps 21 for delivering the liquid through the beverage preparation machine 1 by corresponding pump action. The pump 21 may also be part of another part of the beverage preparation machine 1 as long as it allows for the delivery of liquid through the beverage preparation machine 1.

The delivery unit 2 may further comprise a heater 22 for heating the liquid; here preferably in the delivery unit 2. The heater 22 may also be part of another part of the beverage preparation machine 1 as long as it allows for heating of the liquid being delivered or to be delivered through the beverage preparation machine 1.

The delivery unit 2 may further comprise a cooling unit 23 (here having a chiller 230 and a compressor 231 for circulating a cooling medium via the chiller 230) for chilling the liquid; here preferably in the delivery unit 2. The cooling unit 23 or its chiller 230 according to FIG. 7 is provided at a buffer tank 24. The buffer tank 24 preferably is part of the delivery unit 2 for storing and tempering (e.g. cooling) a defined amount of liquid (e.g. water) ready to be dispensed. Of course, the cooling unit 23 may also be part of another part of the preparation machine 1 as long as it allows for cooling of the liquid being delivered or to be delivered through the beverage preparation machine 1.

The beverage preparation machine 1 further comprises a dispensing unit 3 for dispensing the liquid delivered by or through the delivery unit 2. The dispensing unit 3 is shown in FIGS. 1 to 6 and schematically shown in FIG. 7. The dispensing unit 3 may comprise an outlet port 30 for dispensing the liquid. The liquid may be dispensed or discharged from the dispensing unit 3, e.g., by gravity or by delivery action of the delivery unit 2, preferably the pump 21. A drinking vessel V may be placed below the dispensing unit 3. The beverage preparation machine 1 may comprise a receiving base 4 being positioned below the dispensing unit 3 for carrying the drinking vessel V to receive the dispensed liquid. Here, the receiving base 4 can be adjusted in height to optimally position the drinking vessel V with respect to the dispensing unit 3 irrespective of the size of the drinking vessel V.

The beverage preparation machine 1 may further comprise a drip tray 50 preferably being positioned below the dispensing unit 3 as can be seen in FIG. 7. Here, the drip tray 50 is independent from the receiving base 4, while the drip tray 50 may also be integrally formed with the receiving base 4 in an alternative embodiment.

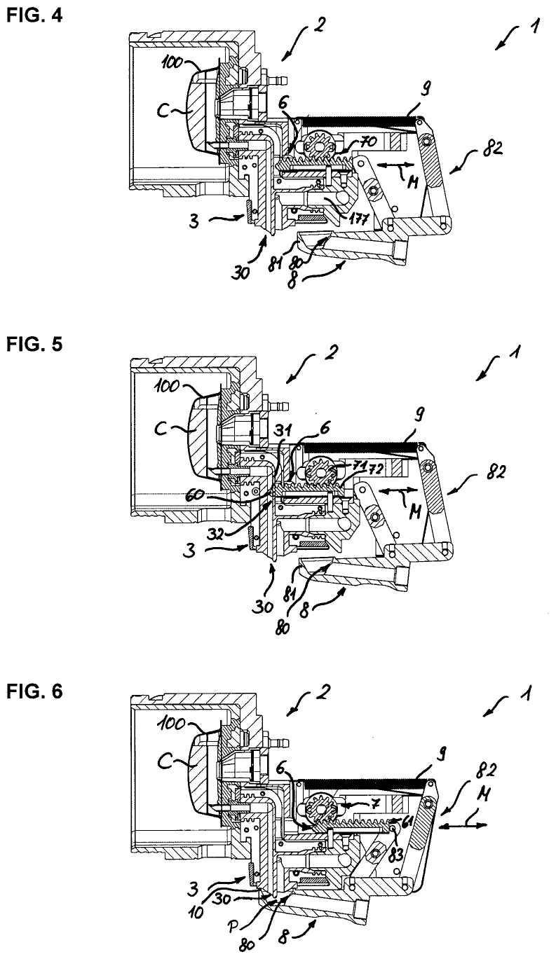

As can be seen in the embodiment of FIGS. 1 to 6, the beverage preparation machine 1 may further comprise a flow restriction element 6 for selectively restricting or stopping the dispensing of liquid through the dispensing unit 3. Here, the flow restriction element 6 is designed as a pinch valve. As can be clearly seen in the comparison of FIGS. 4 and 5, the flow restriction element 6 can be movable between a flow restriction position (see FIG. 5) to restrict or stop liquid flowing through the dispensing unit 3, and a flow position (see FIG. 4) to allow free flow of liquid through the dispensing unit 3.

As can be seen in FIGS. 1 to 6, the flow restriction element 6 may comprise a restriction head 60 being movable relative to a flexible delivery line section 31 so that a cross-section of a liquid flow path 32 through the delivery line section 31 is selectively reduced or eliminated, preferably in the flow restriction position as shown in FIG. 5.

The beverage preparation machine 1 may comprise an actuator 7, e.g. an electric motor, for moving the flow restriction element 6 preferable between the flow position and the flow restriction position. As clearly shown in FIGS. 1 to 3, the actuator 7 can be directly functionally coupled to the flow restriction element 6 for directly moving the flow restriction element 6. Therefore, a rotational movement of the actuator 7 can be transformed into a linear movement of the flow restriction element 6; here through a gear train 70 having, for instance, a pinion gear 71 of the actuator meshing with a gear rack 72 here integrally formed with the flow restriction element 6.

The beverage preparation machine 1 further comprises a collection unit 8. The collection unit 8 is fluidly connectable to the dispensing unit 3 to selectively form a liquid path P (see FIGS. 1, 6 and 7) to collect the liquid dispensed by the dispensing unit 3.

The collection unit 8 can comprise an inlet port 80 for being fluidly connectable to the dispensing unit 3, preferably its outlet port 30, to form the liquid path P. The collection unit 8, preferably at its inlet port 80, may comprise a cup-shaped receiving section 81 for receiving at least part of the dispensing unit 3, preferably at least the outlet port 30, when being fluidly connected to the dispensing unit 3 to form the liquid path P. This can be clearly seen in FIGS. 1 and 6 showing the cup-shaped receiving section 81 in a condition put over the outlet port 30 of the dispensing unit 3 to form the liquid path P. The cup-shape can also be clearly gathered from FIG. 3.

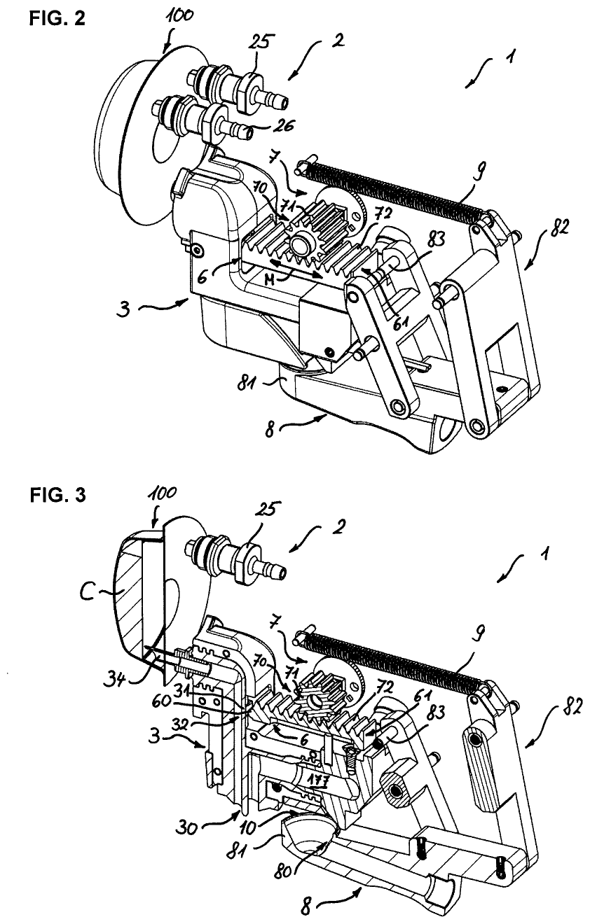

The collection unit 8, preferably at least its inlet port 80, can be relatively movable with respect to the dispensing unit 3, preferably at least its outlet port 30, between a connected position (see FIGS. 1, 6 and 7 (dashed line)) to fluidly connect the collection unit 8 with the dispensing unit 3 to form the liquid path P, and a retracted position (see FIGS. 2 to 5 and 7 (dotted line)) to allow the dispensing unit 3 for dispensing or discharging the liquid out of the beverage preparation machine 1, e.g. in a drinking vessel V as shown in FIG. 7. In the shown embodiment, the relative movement between the dispensing unit 3 and the collection unit 8 is obtained by the dispensing unit 3 being fixedly arranged while the collection unit 8 is movable. In an alternative embodiment, the relative movement may also be obtained by the dispensing unit 3 being movable while the collection unit 8 is fixedly arranged, or both are movable.

The collection unit 8 and preferably its inlet port 80 and/or the dispensing unit 3 and preferably at least its outlet port 30 can be movable by a rotational and/or linear movement, preferably along a defined trajectory. In the embodiment of FIGS. 1 to 6, the movement of the collection unit 8 is obtained through a parallelogram guide mechanism 82 resulting in a combined rotational and linear movement along a defined trajectory. In the embodiment of FIG. 7, the collection unit 8 or at least its inlet port 80 is exemplarily shown to be movable by a rotational movement about a fixed rotational axis X. This rotational movement preferably allows for the collection unit 8 be moved—i.e. pivoted—between the rejected position (see the dotted line in FIG. 7) and the connected position (see the dashed line in FIG. 7).

As can be particularly gathered from FIGS. 4 to 6, a movement of the flow restriction element 6 can at least be partially linked to a relative movement of the collection unit 8 with respect to the dispensing unit 3. As mentioned, the flow restriction element 6 is here preferably linearly moveable along a moving direction M. On a side opposite to the restriction head 60 along the moving direction M, the flow restriction element 6 may comprise a contact surface 61 facing towards a trigger section 83. When being linearly moved away from the dispensing unit 3 or its delivery line section 31, the contact surface 61 approaches the triggering section 83 as can be seen in the comparison from FIGS. 5 and 4. When the flow restriction element 6 is moved further along the moving direction M towards the triggering section 83, the contact surface 61 gets into abutment with the triggering section 83, and when being moved further as shown in FIG. 6, the flow restriction element 6 operates the collection unit 8 via the triggering section 83 to be moved preferably from the retracted position into the connected position to form the liquid path P as shown in FIG. 6. Hence, the movements of the flow restriction element 6 and the collection unit 8 can be at least partially linked to each other.

The movement can preferably be linked such that the flow restriction element 6 is first in the restriction position while the collection unit 8 is in the rejected position (see FIG. 4), then the flow restriction element 6 is in the flow position while the collection unit 8 is in the retracted position (see FIG. 5), and then the flow restriction element 6 is in the flow position while the collection unit 8 is in the connected position (see FIG. 6), and backwards. Hence, the collection unit 8 (as shown in the embodiment of FIGS. 1 to 6) and/or the dispensing unit 3 can thus indirectly be moved through one of the other movable parts being directly moved (e.g. through the actuator 7), i.e. here exemplarily through the flow restriction element 6.

The beverage preparation machine 1 may further comprise a biasing means 9 for allowing the dispensing unit 3, preferably its outlet port 30, and the collection unit 8, preferably its inlet port 80, be biased relative to each other. In the shown embodiment, these elements 3, 8 are biased away from forming the fluid connection and thus preferably towards the retracted position. Hence, the collection unit 8 is guided into the retracted position once the flow restriction element 6 is moved (back) in the moving direction M towards the dispensing unit 3 or its delivery line section 31. However, the dispensing unit 3 and the collection unit 8 may also be biased relative to each other towards forming the fluid connection and thus preferably towards the connected position, if desired.

FIG. 1 also shows an embodiment in which the collection unit 8 can be selectively moved independently from the flow restriction element 6 by a not shown actuator, if desired. On the other hand, the flow restriction element 6 and the collection unit 8 may also be functionally connected so that their movements are always linked to each other. Which of the parts, if any, is directly or indirectly moved by an actuator 7 can be chosen as desired, while the present invention is not limited to any particular layout. Also, any of the described movements may be manually activated or triggered, if desired.

As shown in the embodiment of FIGS. 1 to 6, the mentioned biasing means 9 can comprise a spring, here preferably a tension spring 9. The biasing means 9 may also be a material and/or a design of at least part of the collection unit 8 and/or the dispensing unit 3.

A sealing element 10 may be provided between the dispensing unit 3, preferably its outlet port 30, and the collection unit 8, preferably its inlet port 80 for sealingly closing the liquid path P when being fluidly connected, as depicted in FIGS. 1 and 6.

As is exemplarily shown in FIG. 7, the collection unit 8 can be fluidly connected to a receptacle 5 for collecting the liquid, preferably at a portion downstream from the inlet port 80. As can be seen in FIG. 7, the receptacle 5 may be identical or integral with the drip tray 50 so that collection and disposal of any residues is facilitated.

In a preferred embodiment, the collection unit 8 or the receptacle 5 may be fluidly connected or connectable (e.g. by means of a control valve 51) to the delivery unit 2 to from a closed circulation loop. Hence, any collected liquid can be re-circulated to avoid any unnecessary disposal of liquid. Also, a re-circulation could be used for cleaning purposes to allow for a corresponding cleaning liquid be circulated through the whole beverage preparation machine, i.e. through the delivery unit 2, the dispensing unit 3 and preferably also the collection unit 8 via the liquid path P, to allow for an economic cleaning step.

As is exemplarily illustrated in FIG. 1, the beverage preparation machine 1 may further comprise a UV lamp 11, 12, like a UV LED lamp, for irradiating the dispensing unit 3, preferably the outlet port 30, and/or the collection unit 8, preferably the inlet port 80. Therefore, the UV lamp 11 can be provided at the collection unit 8 so that it is directed towards the dispensing unit 3, preferably the outlet port 30, when being fluidly connected to the dispensing unit 3, as shown in FIG. 1. The UV lamp 12 may also be provided at the dispensing unit 3 so that it is directed towards the collection unit 8, preferably the inlet port 80, when being fluidly connected to the collection unit 8, as also shown in FIG. 1. Also other locations for the UV lamp 11, 12 or other irradiation directions are possible.

The beverage preparation machine 1 may further comprise a control unit (not shown) configured for controlling any desired feature of the beverage preparation machine 1. For example, the control unit may be configured for delivering the liquid through the beverage preparation machine 1, preferably be controlling the pump 21. The control unit may also be configured for selectively fluidly connecting the connection unit 8 to the dispensing unit 3, preferably by controlling the actuator 7 to move the collection unit 8 relative to the dispensing unit 3. The control unit may also be configured for restricting or stopping the liquid flow, preferably by moving the flow restriction element 6, here preferably by controlling the actuator 7. The control unit may also be configured for controlling a complete beverage preparation (or cleaning) step including controlling of the heater 22 or the cooling unit 23 and the like.

With respect to FIG. 7, the beverage preparation machine 1 may comprise a plurality of additional optional features. For instance, a main liquid (e.g. water) supply 13 may be part of or fluidly connected to the delivery unit 2 to store and supply a particular amount of liquid, like water, for the beverage preparation machine 1. For delivery of the liquid from the supply 13, one of the pumps 21 can be provided to deliver the liquid from the supply 13 at least through part of the delivery unit 2, here into the buffer tank 24. A filter 14 may be provided in the delivery unit 2 for filtering the liquid be delivered through at least part of the delivery unit 2. A UV lamp 15 may be provided in the delivery unit 2 for sanitizing the liquid being delivered through the beverage preparation machine 1 and preferably through the delivery unit 2. Therefore, another pump 21 can be provided to deliver the liquid here from the buffer tank 24 to the dispensing unit 3. A branch-off passage 16 may be provided along the delivery lines 20 of the delivery unit 2 to re-circulate liquid here to the buffer tank 24 to provide an internal closed loop, e.g. for sanitizing purposes by exposing the circulated liquid to UV light by the UV lamp 15.

As can be seen in FIG. 7, the beverage preparation machine 1 may further comprise a beverage additive section 17 for delivering and dispensing additives via the dispensing unit 3, preferably the outlet port 30. The beverage additive section 17 may add additives to the liquid at a position downstream the buffer tank 24, e.g. for preparing a beverage product. The beverage additive section 17 may add the additives at a position upstream or downstream of the dispensing unit 3, or at the dispensing unit 3, to the liquid.

The beverage additive section 17 may comprise its own pump 170 for delivering the required amount of liquid through the beverage addition section 17. The beverage additive section 17 may further comprise a heater 171 for heating the so delivered additive/liquid. An air pump 172 may be provided for injecting air into the additive/liquid delivered along the beverage additive section 17. The beverage additive section 17 may comprise valves 173, 174 (e.g. two-way valves) for selectively delivering the liquid through an air injection line 175 connected to the air pump 172, or directly towards the dispensing unit 3 via a dispensing line 176. The air injection line 175 and the dispensing line 176 may merge in a discharge line 177 in or leading into the dispensing unit 3 so as to add the additives to the liquid (e.g. by mixing).

The beverage preparation machine 1 may further comprise an in-line carbonation device 18 for entering carbon dioxide (CO2) into the liquid circulating through the beverage preparation machine 1 and preferably the delivery unit 2.

In the embodiment of FIGS. 1 to 6, an infusion of a brewing-type beverage preparation machine 1 is shown in which the comestible product C is here carried in a capsule 100 which can be functionally inserted into a beverage preparation chamber 33 of the dispensing unit 3. A liquid injector element 25 of the delivery unit 2 can preferably be arranged to penetrate the capsule 100 for injecting the liquid delivered by the delivery unit 2 into the capsule 100 for preparing a beverage by interaction (brewing or infusion) with the comestible product C when the capsule 100 is functionally inserted in the beverage preparation chamber 33. An additional air injector 26 of the delivery unit 2 may preferably be arranged to penetrate the capsule 100 for injecting air into the capsule 100 when being functionally inserted in the beverage preparation chamber 33 to support the beverage preparation step.

The dispensing unit 3 may further comprise a discharge element 34 for penetrating the capsule 100 here at a lower level when being functionally inserted in the beverage preparation chamber 33 to allow for the liquid (e.g. beverage product) be discharged from the capsule 100; preferably after beverage preparation by interaction of the liquid (e.g. water) with the comestible product C. The discharge element 34 is preferably fluidly connected with the outlet port 30, more preferred through the mentioned flexible delivery line section 31.

Even though two different types of beverage preparation machines 1 are described, the present invention is not limited to these embodiments but any type of beverage preparation machine 1 which delivers and dispenses a liquid for a consumer is covered by the present invention.

In the following, a method for dispensing a liquid is described.

In a first step, a liquid is delivered through a delivery unit (preferably the delivery unit 2) of a beverage preparation machine (preferably the beverage preparation machine 1 according to the present invention).

In a second step, the liquid delivered by the delivery unit 2 is dispensed via or through a dispensing unit (preferably the dispensing unit 3) of the beverage preparation machine 1.

In a third step, a collection unit (preferably the collection unit 8) of the beverage preparation machine 1 is selectively fluidly connected with the dispensing unit 3 to form a liquid path (preferably the liquid path P) for collecting the liquid dispensed by the dispensing unit 3.

The step of delivering a liquid may comprise preparing a beverage based on the liquid preferably in a beverage preparation chamber (preferably the beverage preparation chamber 33) upstream from or inside the dispensing unit 3. Then, the step of dispensing the liquid may comprise dispensing the prepared beverage via or through the dispensing unit 3.

The dispensing of beverage may be restricted or stopped as shown in FIG. 5. This can be useful, for instance, to allow a sufficient infusion with or dissolution of a comestible product C, e.g. to prepare a beverage. After a defined duration after the start of the beverage preparation, the dispensing of the prepared beverage can be started as illustrated in FIG. 4. This can be done by accordingly moving the flow restriction element 6 between the restricted position of FIG. 5 and the flow position of FIG. 4.

The liquid path P can be formed before the step of dispensing the liquid or prepared beverage is started, as illustrated in FIG. 6. This can be useful to protect the dispensing unit 3 or its outlet port 30 from contamination. Also, if heated liquid is to be dispensed, steam may exit the dispensing unit 2 during beverage preparation or at the beginning of the delivery of the liquid/beverage. This steam can then be collected through the connection unit 8 and thus a risk for a user, e.g. of scalding, can be reduced. During the liquid path P still being formed, the dispensing of liquid or prepared beverage can already be started. Hence, any potential steam or an initial amount of liquid/beverage may be collected, if desired. After a defined duration, the dispensing unit 3 can then be cleared from the collection unit 8 to freely dispense the liquid or prepared beverage, e.g. into a drinking vessel V.

The liquid path P can be formed also after the dispensing of liquid or prepared beverage is terminated as depicted in FIG. 6. Hence, any residues dripping from the dispensing unit 3 can be securely collected.

The step of fluidly connecting may comprise relative movement between the dispensing unit 3 and the collection unit 8. This preferably to fluidly connect an outlet port (preferably the outlet port 30) of the dispensing unit 3 and an inlet port (preferably the inlet port 80) of the collection unit 8.

The step of collecting (at least part of) the liquids may comprise collection of the respective liquid or prepared beverage in a receptacle 5, like the drip tray 50. Alternatively or additionally, the step of collecting (at least part of) the liquid may comprise recirculating the liquid to the delivery unit 2, e.g. in case of a cleaning step to thus preferably circulate a corresponding liquid through the beverage preparation machine 1.

The liquid may be heated or cooled before or during delivery of the liquid to thus provide a hot or chilled beverage. The heated liquid may also be used for cleaning (e.g. rinsing) purposes, e.g. in case of a closed circulation loop via the collection unit 8.

The dispensing unit 3, preferably the outlet port 30, and/or the collection unit 8, preferably the inlet port 80, can be cleaned or sanitized, preferably before, during and/or after the dispensing and/or collection of the liquid or prepared beverage. Cleaning or sanitization may be obtained, for instance, as described before by delivering a corresponding liquid, like heated water, along the corresponding liquid path P. In a preferred embodiment, the step of sanitization preferably comprises irradiating UV light, e.g. by the UV lamps 11, 12, to the dispensing unit 3, preferably the outlet port 30, and/or the collection unit 8, preferably the inlet port 80.

The present invention is not limited to the embodiments as described herein above as long as being covered by the appended claims.

1. Beverage preparation machine, comprising:
a delivery unit for delivering a liquid through the beverage preparation machine,
a dispensing unit for dispensing the liquid delivered by the delivery unit, and
a collection unit being fluidly connectable to the dispensing unit to selectively form a liquid path to collect the liquid dispensed by the dispensing unit.

2. Beverage preparation machine according to claim 1,
the dispensing unit comprises an outlet port for dispensing the liquid, and/or wherein the collection unit comprises an inlet port for being fluidly connectable to the dispensing unit to form the liquid path.

3. Beverage preparation machine according to claim 1, wherein the collection unit comprises a cup-shaped receiving section for receiving at least part of the dispensing unit.

4. Beverage preparation machine according to claim 1, wherein the collection unit is relatively moveable with respect to the dispensing unit between a connected position to fluidly connect the collection unit with the dispensing unit to form the liquid path, and a retracted position to allow the dispensing unit for dispensing the liquid out of the beverage preparation machine.

5. Beverage preparation machine according to claim 1, further comprising a biasing member for allowing the dispensing unit and the collection unit be biased relative to each other towards or away from forming the fluid connection, and
a sealing element is provided between the dispensing unit and the collection unit for sealingly closing the liquid path when being fluidly connected.

6. Beverage preparation machine according to claim 1, wherein the collection unit is fluidly connected to a receptacle for collecting the liquid.

7. Beverage preparation machine according to claim 1, further comprising a flow restriction element for selectively restricting or stopping the dispensing of liquid through the dispensing unit,
wherein the flow restriction element is moveable between a flow restriction position to restrict or stop liquid flowing through the dispensing unit, and a flow position to allow free flow of liquid through the dispensing unit, and
wherein a movement of the flow restriction element is at least partially linked to a relative movement of the collection unit with respect to the dispensing unit.

8. Beverage preparation machine according to claim 1, further comprising a UV lamp for irradiating the dispensing unit.

9. Beverage preparation machine according to claim 1, wherein the beverage preparation machine comprises a heater for heating the liquid preferably in the delivery unit.

10. Method for dispensing a liquid, comprising:
delivering a liquid through a delivery unit of a beverage preparation machine, preferably the beverage preparation machine comprising:
a delivery unit for delivering a liquid through the beverage preparation machine,
a dispensing unit for dispensing the liquid delivered by the delivery unit, and
a collection unit being fluidly connectable to the dispensing unit to selectively form a liquid path to collect the liquid dispensed by the dispensing unit,
dispensing the liquid delivered by the delivery unit via a dispensing unit of the beverage preparation machine, and
selectively fluidly connecting a collection unit of the beverage preparation machine with the dispensing unit to form a liquid path for collecting at least part of the liquid dispensed by the dispensing unit.

11. Method according to claim 10, wherein the step of delivering a liquid comprises preparing a beverage based on the liquid, and
the step of dispensing the liquid comprises dispensing the prepared beverage via the dispensing unit.

12. Method according to claim 10, wherein the liquid path is formed before the step of dispensing the liquid or prepared beverage is started, then the dispensing of liquid or prepared beverage is started, and after a defined duration, the dispensing unit is cleared from the collection unit to freely dispense the liquid or prepared beverage, and
wherein the liquid path is formed after the dispensing of liquid or prepared beverage is terminated.

13. Method according to claim 10, wherein the step of fluidly connecting comprises relative movement between the dispensing unit and the collection unit.

14. Method according to claim 10, wherein the step of collecting the liquid comprises collection of the liquid or prepared beverage in a receptacle and recirculating the liquid to the delivery unit.

15. Method according to claim 10, wherein the liquid is heated or cooled before or during delivery of the liquid.
